(19) United States
(12) Patent Application Publication
(10) Pub. No.: US 2025/0317880 A1
(43) Pub. Date: Oct. 9, 2025

(54) Detecting Non-Line of Sight Conditions Using Frequency-Sweep Techniques

(71) Applicant: Qorvo US, Inc., Greensboro, NC (US)

(72) Inventors: Lisa Meilhac, Valbonne (FR); Julien Schrive, Toulouse (FR); Abdallah Dhouibi, Toulouse (FR)

(21) Appl. No.: 19/088,774

(22) Filed: Mar. 24, 2025

Related U.S. Application Data
(60) Provisional application No. 63/575,956, filed on Apr. 8, 2024.

(51) Int. Cl. H04W 56/00; H04B 1/00

(52) U.S. Cl. CPC H04W 56/0095; H04B 1/0092

(57) ABSTRACT

Systems, devices, and methods for detecting Non-Line of Sight conditions using frequency-sweep techniques are disclosed. In an exemplary aspect, a method is disclosed. In some embodiments, the method includes estimating a first propagation time between a first device and a second device using a first signal communicated at a first carrier frequency. The method may further include estimating a second propagation time between the first device and the second device using a second signal communicated at a second carrier frequency, wherein the second carrier frequency is different than the first carrier frequency. The method may further include determining whether a Non-Line of Sight (NLOS) condition exists between the first device and the second device based on the first propagation time and the second propagation time.

### CROSS-REFERENCE TO RELATED APPLICATION(S)

The present application claims the benefit of U.S. Provisional Application No. 63/575,956, entitled “DETECTING NON-LINE OF SIGHT CONDITIONS USING FREQUENCY-SWEEP TECHNIQUES” and filed on Apr. 8, 2024, which is hereby incorporated by reference in its entirety.

### TECHNICAL FIELD

The present disclosure relates generally to detecting the presence of obstacles between communication devices in sensing and localization systems, which may also be referred to as detecting Non-Line of Sight conditions.

### BACKGROUND

Various wireless technologies such as Wi-Fi, Ultra-Wideband (UWB), Bluetooth and others can be used in industrial and personal applications to estimate device location. The development and deployment of connected devices and the emergence of Internet of things (IoT) brings a wide range of new use cases, such as access control, localization of goods in a warehouse, or tracking of people activity in various environments.

In some applications, anchors at certain fixed reference positions are used to determine the location of a device (e.g., a tag) based on communication between the device and the anchors. To determine a precise location of a device a few pieces of information may be estimated, such as the distance between the device and each anchor and/or the orientation between devices. In two-way ranging applications, utilizing two-way communication between two devices a precise position of a device can be determined. These kinds of approaches are well known as range-based approaches. Several methods are used to determine distance such as Received Signal Strength (RSS) and Time of Arrival (ToA) techniques.

Modern ranging technology, such as UWB technology, may typically be accurate to within a few centimeters of error in distance estimation and within a few degrees for orientation estimation. High degrees of accuracy are achievable when operating in Line of Sight (LOS) conditions between a transmitter (e.g., a tag) and receiver (e.g., an anchor). However, a challenging issue in localization and ranging applications is the existence of an obstacle located between a transmitter and a receiver, referred to as a Non-Line of Sight (NLOS) condition. For example, the presence of obstacles such as furniture, walls, doors, and even people can induce undesired effects on distance estimates due to propagation of radio signals through an obstacle on the way to a receiver. In the case of distance estimation, attenuation and wave velocity variation are induced by different materials in obstacles, which can lead to overestimation of the distance between devices. In the case of angle of arrival (AoA) estimation, the effects are a little less well known in literature, but it has been observed that attenuation and velocity variation induce inconsistencies of estimates with a spread of the measured values. Due to these effects, the performance of conventional localization algorithms is degraded, making localization estimation erroneous and unreliable. This represents a significant problem especially for use cases where highly precise and reliable localization are needed, such safety applications involving people in dangerous environments, for example. Thus, there is a need for efficient and reliable NLOS condition detection and mitigation.

### SUMMARY

Embodiments of the present disclosure include systems, devices, and methods for detecting Non-Line of Sight conditions using frequency-sweep techniques.

In an exemplary aspect, a method is disclosed. In some embodiments, the method includes estimating a first propagation time between a first device and a second device using a first signal communicated at a first carrier frequency. The method may further include estimating a second propagation time between the first device and the second device using a second signal communicated at a second carrier frequency, wherein the second carrier frequency is different than the first carrier frequency. The method may further include determining whether a Non-Line of Sight (NLOS) condition exists between the first device and the second device based on the first propagation time and the second propagation time.

In another exemplary aspect, a communication device is disclosed that includes a processor. In some embodiments, the processor is configured to estimate a first propagation time between a first device and the communication device using a first signal communicated at a first carrier frequency. The processor may further be configured to estimate a second propagation time between the first device and the communication device using a second signal communicated at a second carrier frequency, wherein the second carrier frequency is different than the first carrier frequency. The processor may further be configured to determine whether a Non-Line of Sight (NLOS) condition exists between the first device and the communication device based on the first propagation time and the second propagation time.

In another exemplary aspect, a non-transitory computer-readable medium (CRM) having program code recorded thereon is disclosed. In some embodiments, the program code includes code for causing a communication device to estimate a first propagation time between a first device and the communication device using a first signal communicated at a first carrier frequency. The program code may further include code for causing the communication device to estimate a second propagation time between the first device and the communication device using a second signal communicated at a second carrier frequency, wherein the second carrier frequency is different than the first carrier frequency. The program code may further include code for causing the communication device to determine whether a Non-Line of Sight (NLOS) condition exists between the first device and the communication device based on the first propagation time and the second propagation time.

Additional aspects, features, and advantages of the present disclosure will become apparent from the following detailed description.

### BRIEF DESCRIPTION OF THE DRAWINGS

The accompanying drawing figures incorporated in and forming a part of this specification illustrate several aspects of the disclosure, and together with the description, serve to explain the principles of the disclosure.

FIG. 1. illustrates an example of a propagation path for LOS and NLOS condition, according to some aspects of the present disclosure.

FIG. 2 illustrates an example of a method of detecting a NLOS condition, according to some aspects of the present disclosure.

FIG. 3 illustrates ultra-wideband communication devices in a two-way ranging application using frequency sweep according to some aspects of the present disclosure.

FIG. 4. illustrates an example of a communication device, according to some aspects of the present disclosure.

### DETAILED DESCRIPTION

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, systems, and methods, and any further application of the principles of the present disclosure are fully contemplated and included within the present disclosure as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

Systems, methods, and devices are presented herein for the detection and mitigation of NLOS conditions existing between wireless communication devices. Many localization and ranging techniques involve estimation of propagation delay or time of flight (ToF) for wireless signals communicated between devices, with the ToF translated into distance calculations under the assumption of LOS conditions. In two-way ranging and localization the existence of obstacles between communication devices, resulting in a NLOS condition, can lead to inaccurate distance and/or location estimates. Disclosed herein are techniques for the detection of NLOS conditions that are suitable for implementation in communication devices. Techniques are based on the recognition that measurements taken using signals with different carrier frequencies can be used to detect NLOS conditions.

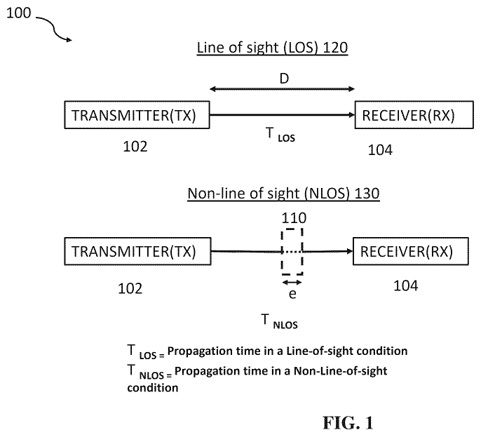

FIG. 1 illustrates examples of communication involving a transmitter 102 and a receiver 104 in LOS 120 and NLOS 130 conditions, according to some aspects of the present disclosure. In these scenarios, the transmitter 102 and receiver 104 are located a certain distance apart, represented as “D” in FIG. 1. The transmitter 102 and receiver 104 may represent communication devices in a localization or ranging scenario, such as tags and anchors in time difference of arrival (TDoA) scenarios or two-way ranging scenarios.

In the LOS condition 120, there are no obstacles between the transmitter 102 and the receiver 104. Communication signals transmitted by the transmitter 102 and received by the receiver 104 travel only through air. The propagation time between the transmitter 102 and the receiver 104 is represented by T_{LOS}.

In the NLOS condition 130, at least one obstacle 110 exists between the transmitter 102 and the receiver 104. The obstacle 110 can be any physical entity such as furniture, a wall, a door, or even human beings. A thickness of the obstacle is represented by “e,” and the propagation time is represented by T_{NLOS}. The presence of the obstacle may materially impact the propagation time between the transmitter 102 and receiver 104, as compared to the LOS condition 120. Thus, if position or location determination is based on LOS assumptions, such as wave velocity in air, the position or location determination may be materially impacted by the presence of an obstacle 110.

This disclosure recognizes that the radio wave velocity within a solid obstacle in an environment changes as a function of carrier frequency and that this principle can be exploited to distinguish between NLOS and LOS conditions. In some embodiments, communication signals may be transmitted using different carrier frequencies, with the propagation times measured at those different carrier frequencies. A NLOS condition may be determined to exist if measured propagation times are different at the different carrier frequencies.

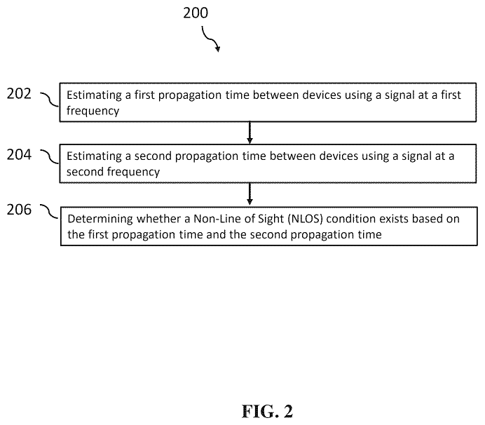

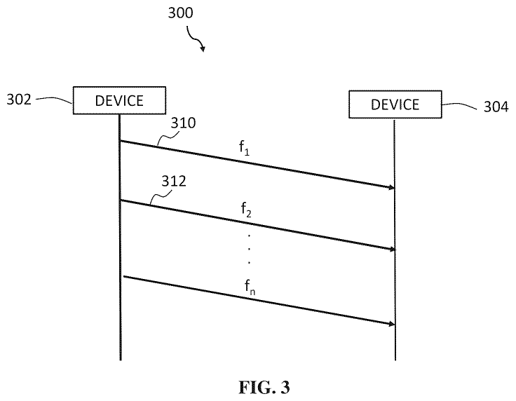

FIG. 2 illustrates a method 200 of detecting a NLOS condition, according to some aspects of the present disclosure. FIG. 3 is a diagram of an exemplary communication system 300 in a sensing application or other application in which a location is determined, according to some aspects of the present disclosure. The system includes a first device 302 (e.g., a transmitter) transmitting signals to a second device 304 (e.g., a receiver). The devices 302 and 304 may, as examples, represent a tag and anchor, respectively, or an anchor and tag, respectively, in a UWB TDoA application, or two devices in a two-way ranging application. The devices 302, 304 may employ wireless communication technologies, such as UWB, WiFi, or Bluetooth, as examples, for the communication signals discussed herein. The method 200 is described further below with reference to the communication system 300.

In step 202, a communication signal is transmitted using a first frequency, and a first propagation time is estimated using the signal at the first carrier frequency. As an example, as shown in FIG. 3, a first signal is transmitted (310) from device 302 to device 304 using carrier frequency f₁. The propagation time (or ToF) between devices 302 and 304 may be estimated using any known method, depending on the context or application. For example, device 302 may be a tag or anchor in a TDoA application, and device 304 may be a corresponding anchor or tag, respectively, and a propagation time may be determined using TDoA techniques.

In step 204, a communication signal is transmitted using a second carrier frequency, and a second propagation time is estimated using the signal at the second carrier frequency. Examples of carrier frequencies that may be used are various UWB carrier frequencies, such as so-called Channel 5 at 6489.6 MHz and so-called Channel 9 at 7987.2 MHz. Other frequencies around 6 GHz or 8 GHz, as examples, may be used. Other Bluetooth or WiFi carrier frequencies may be used. As an example, as shown in FIG. 3, a second signal is transmitted (312) from device 302 to device 304 using carrier frequency f₂. The propagation time (or ToF) between devices 302 and 304 may be estimated using any known method, depending on the context. For example, device 302 may be a tag or anchor in a TDoA application, and device 304 may be a corresponding anchor or tag, respectively, and the propagation time may be determined using TDoA techniques. In some embodiments, each of the communication signals may be known reference signals and/or the devices 302, 304 may be synchronized in known ways that allow the receiving device 304 to determine the propagation delay or time of flight.

Additional signals may be transmitted using additional carrier frequencies, such that up to an integer number “n” signals may be transmitted at up to n different frequencies, and corresponding propagation times determined for the n different signals. Example transmissions are illustrated in FIG. 3, showing multiple transmissions at frequencies f₁, f₂, . . . , fₙ. The process may be repeated a number of times, and average values may be determined at each frequency of interest, for example. In some two-way ranging protocols, messages are exchanged in both directions between devices 302, 304, as would have been understood in the art. In the case of such two-way ranging protocols, the messages in both directions may be transmitted using the same carrier frequency to obtain a propagation time estimate at a first frequency. Then the process may be repeated at a second frequency to obtain a propagation time estimate for a second frequency. This process for two-way ranging may be repeated for several different frequencies. After propagation times at different frequencies are obtained, a determination may be made whether a NLOS condition exists, as in step 206, described below.

In step 206, the first propagation time (that used the first carrier frequency) is compared with the second propagation time (that used the second carrier frequency) to determine whether the propagation times at the different frequencies are substantially equal, or equal to each other within some error tolerance, such as if the propagation times differ from each other by 1%, 5%, etc. Thus, in some embodiments, a difference between the two propagation times may be compared to a threshold, or the difference between the two propagation times may be converted to a percentage difference and compared to a threshold. If the first propagation time is different than the second propagation time, a NLOS condition is determined to exist. This process may be repeated if desired for a number of signals transmitted at various frequencies, with propagation times compared at different frequencies to determine whether a NLOS condition exists. If propagation times for multiple frequencies are substantially equal, a LOS condition may be determined to exist. If a LOS condition exists, the method may further include determining a distance between devices (or a location of one of the devices) based on a propagation time and speed of light in air.

Suppose propagation time between device 302 and device 304 is represented by P₁ at frequency f₁ and represented by P₂ at frequency f₂. In determining whether a NLOS condition exists, a difference P₁−P₂ or P₂−P₁ may be computed, a ratio of the differences to P₁ or P₂ may be computed (to determine a percentage difference), or P₁ may otherwise be compared to P₂.

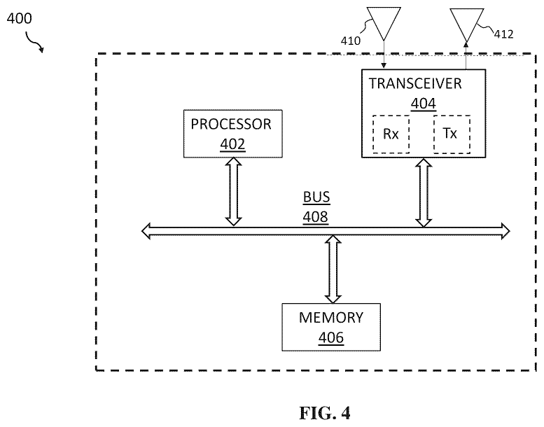

FIG. 4 is a detail diagram of an exemplary communication device 400, according to some aspects of the present disclosure. The communication device 400 represents a more detailed diagram of the transmitter 102, receiver 104, or devices 302, 304, or any other communication device discussed herein. In some embodiments, device 400 includes a processor 402, a transceiver 404, a memory 406, and a bus 408 connected as shown. The communication device 400 may further include one or more receive antennas 410 and one or more transmit antennas as shown 412. The hardware components of device 400 may be communicatively coupled to bus 408. In some embodiments, bus 408 can be used for processor 402 to communicate between cores and/or with memory 406. Processor 402 may include one or more general-purpose processors and/or one or more special-purpose processors (such as digital signal processing chips, graphics acceleration processors, and/or the like). The transceiver 404 may include a transmitter (Tx) and/or receiver (Rx) as shown. Processor 402 may process wireless signals received by transceiver 404, such as ranging signal/data from UWB communication. The communication device 400 may be configured to use UWB, WiFi, or Bluetooth communications and protocols. The transceiver 404 may include analog and digital circuitry for transmitting and/or receiving messages at the physical layer. The processor 402 may perform baseband or other types of processing, such as implementing higher layers of a protocol stack.

Memory 406 may include one or more non-transitory storage devices that may include local and/or network accessible storage, a disk drive, a drive array, an optical storage device, a solid-state storage device such as a random access memory (RAM) and/or a read-only memory (ROM), a programmable ROM, a flash-updateable ROM, and/or the like. Such storage devices may be configured to implement any appropriate data storage, including without limitation, various file systems, database structures, and/or the like. The memory 406 may be a non-transitory computer-readable medium used for storing programming instructions and other computer code for carrying out various steps described herein, such as the steps described with respect to the method 200.

Without being bound by theory, some additional technical understanding and background is presented below. It is recognized that propagation time may depend on dielectric parameters such as permittivity and permeability of the material of the obstacle. According to electromagnetic theory, the velocity of a radio wave in a material depends on electrical permittivity (∈) and magnetic permeability (μ) of the material. In a vacuum or in air the velocity is constant regardless of the carrier frequency. In case of natural materials, these parameters are usually considered relative to constant parameters in a vacuum or in air (∈₀ and μ₀), with relative electrical permittivity represented as ∈ᵣ and relative magnetic permeability represented as μᵣ. Then the wave velocity ν in meters/second can be expressed as function of light speed in vacuum (C), the relative permittivity (∈ᵣ) and the relative permeability (μᵣ) as:

$$v = \frac{c}{\sqrt{{ϵ}_{r} {μ}_{r}}} \qquad ( 1 )$$

The relative electrical permittivity and magnetic permeability parameters may be dependent on the propagation medium. Furthermore, these parameters may be expressed as a complex function of the radio wave pulsation (ω=2πf with f the carrier frequency). Several models such as Drude, Debye or the Nicolson-Ross-Weir (NRW) conversion show the direct dependence of permittivity and permeability to the carrier frequency. Based on this, the wave velocity in material will also be affected by this frequency. By using a sufficient sweep between several distinct frequencies during a ranging process, the induced effects of the material may be characterizable.

Considering the propagation of a radio wave between a transmitter, such as transmitter 102 or device 302, and a receiver, such as receiver 104 or device 304, the propagation time in a LOS condition (T_{LOS}), such as in LOS condition 120, will depend on the distance D and the velocity in air (νₐᵢᵣ) regardless of the carrier frequency as:

$${T}_{LOS =} \frac{D}{{v}_{air}} \qquad ( 2 )$$

The propagation time will change when there is an obstacle, such as obstacle 110, in between the transmitter and receiver, as in the NLOS condition 130. The propagation time in this NLOS condition can be determined using wave velocity in the obstacle using its material property and thickness of the obstacle. Thus, T_{NLOS} can be represented as

$${T}_{NLOS} = {T}_{LOS} - {τ}_{LOS} + {τ}_{NLOS} \qquad ( 3 )$$

where τ_{NLOS} is the propagation time inside the obstacle and τ_{LOS} is the equivalent delay in LOS condition for the same thickness e. These two parameters are given by:

$${τ}_{NLOS} = \frac{e}{vm} \qquad ( 4 )$$

$${τ}_{LOS} = \frac{e}{vair} \qquad ( 5 )$$

In terms of velocity variation in a solid object, a concept of equivalent velocity can be expressed as:

$${v}_{eq} = \{ \begin{matrix}{v}_{air} & ← LOS \\ {v}_{air} \cdot k & ← NLOS\end{matrix}$$

Where k represents the velocity variation effect on the total measurement induced by the material and k∈(0,1).

As the radio wave velocity inside the material will change in function of the carrier frequency, this variation will be different for distinct frequencies. Thus, successive measurements of the propagation time in NLOS condition at different carrier frequencies can show the variation of velocity as the measured delays will be:

$${T}_{N}^{{f}_{1}} = {T}_{L} - {τ}_{L} + {τ}_{N}^{{f}_{1}}$$

$${T}_{N}^{{f}_{2}} = {T}_{L} - {τ}_{L} + {τ}_{N}^{{f}_{2}}$$

where (⋅)^{f}^{ᵢ} denotes the propagation delay measurement made at frequency fᵢ, “N” represents NLOS, and “L” represents LOS. The velocity variation inside the material can then be isolated by computing the delta between measurements as:

$$\begin{matrix}Δ T & = {T}_{N}^{{f}_{2}} - {T}_{N}^{{f}_{1}} \\ & = {τ}_{N}^{{f}_{2}} - {τ}_{N}^{{f}_{1}} \\ & = \frac{e}{c} ( \sqrt{{ϵ}_{r}^{{f}_{2}} {μ}_{r}^{{f}_{2}}} - \sqrt{{ϵ}_{r}^{{f}_{1}} {μ}_{r}^{{f}_{1}}} )\end{matrix}$$

In case of LOS situations, ΔT will be given by ΔT=T_{L}^{f}^{₂}−T_{L}^{f}^{₁} and will equal 0 due to constant velocity in air regardless of the carrier frequency. Furthermore, the ratio between propagation times allows for isolation of the total velocity variation on the whole propagation path (in air and through the obstacle) as:

$$\begin{matrix}χ & = \frac{{T}_{N}^{{f}_{2}}}{{T}_{N}^{{f}_{1}}} \\ & = \frac{D}{{v}_{eq}^{{f}_{2}}} \cdot \frac{{v}_{eq}^{{f}_{1}}}{D} \\ & = \frac{\sqrt{{ϵ}_{r}^{{f}_{2}} {μ}_{r}^{{f}_{2}}}}{\sqrt{{ϵ}_{r}^{{f}_{1}} {μ}_{r}^{{f}_{1}}}}\end{matrix}$$

This value is characterizable as follows:

$$χ = 1 in LOS cases or when {v}_{eq}^{{f}_{1}} = {v}_{eq}^{{f}_{2}}$$

$$χ > 1 in NLOS cases or where {v}_{eq}^{{f}_{1}} > {v}_{eq}^{{f}_{2}}$$

$$χ < 1 in NLOS cases or where {v}_{eq}^{{f}_{1}} < {v}_{eq}^{{f}_{2}}$$

Persons skilled in the art will recognize that the apparatus, systems, and methods described above can be modified in various ways. Accordingly, persons of ordinary skill in the art will appreciate that the embodiments encompassed by the present disclosure are not limited to the particular exemplary embodiments described above. In that regard, although illustrative embodiments have been shown and described, a wide range of modification, change, and substitution is contemplated in the foregoing disclosure. It is understood that such variations may be made to the foregoing without departing from the scope of the present disclosure. Accordingly, it is appropriate that the appended claims be construed broadly and in a manner consistent with the present disclosure.

1. A method comprising:
estimating a first propagation time between a first device and a second device using a first signal communicated at a first carrier frequency;
estimating a second propagation time between the first device and the second device using a second signal communicated at a second carrier frequency, wherein the second carrier frequency is different than the first carrier frequency; and
determining whether a Non-Line of Sight (NLOS) condition exists between the first device and the second device based on the first propagation time and the second propagation time.

2. The method of claim 1, further comprising determining a first distance between the first device and the second device, when a NLOS condition is determined not to exist.

3. The method of claim 1, wherein the first device is a tag in an ultra-wideband network and the second device is an anchor in the ultra-wideband network, and wherein the method is performed in the second device.

4. The method of claim 3, further comprising:
receiving the first signal at the second device; and
receiving the second signal at the second device.

5. The method claim 1, wherein the first device and the second device are ultra-wideband communication devices in a two-way ranging application.

6. The method of claim 1, wherein the NLOS condition is determined to exist when a difference between the first propagation time and the second propagation time exceeds an error threshold.

7. The method of claim 1, further comprising:
estimating at least one additional propagation time using a third signal at a third carrier frequency, wherein the third carrier frequency is different than the first and second carrier frequencies, and wherein the determining whether the NLOS condition exists is further based on the third signal.

8. A communication device comprising:
a processor configured to:
estimate a first propagation time between a first device and the communication device using a first signal communicated at a first carrier frequency;
estimate a second propagation time between the first device and the communication device using a second signal communicated at a second carrier frequency, wherein the second carrier frequency is different than the first carrier frequency; and
determine whether a Non-Line of Sight (NLOS) condition exists between the first device and the communication device based on the first propagation time and the second propagation time.

9. The communication device of claim 8, wherein the processor is further configured to:
determine a first distance between the first device and the communication device, when a NLOS condition is determined not to exist.

10. The communication device of claim 8, wherein the first device is a tag in an ultra-wideband network, and the communication device is an anchor in the ultra-wideband network.

11. The communication device of claim 10, further comprising:
a receiver configured to:
receive the first signal; and
receive the second signal.

12. The communication device of claim 8, wherein the first device and the communication device are ultra-wideband communication devices in a two-way ranging application.

13. The communication device of claim 8, wherein the NLOS condition is determined to exist when a difference between the first propagation time and the second propagation time exceeds an error threshold.

14. The communication device of claim 8, wherein the processor is further configured to:
estimate at least one additional propagation time using a third signal at a third carrier frequency, wherein the third carrier frequency is different than the first and second carrier frequencies, and wherein the determining whether the NLOS condition exists is further based on the third signal.

15. A non-transitory computer-readable medium (CRM) having program code recorded thereon, the program code comprising:
code for causing a communication device to estimate a first propagation time between a first device and the communication device using a first signal communicated at a first carrier frequency;
code for causing the communication device to estimate a second propagation time between the first device and the communication device using a second signal communicated at a second carrier frequency, wherein the second carrier frequency is different than the first carrier frequency; and
code for causing the communication device to determine whether a Non-Line of Sight (NLOS) condition exists between the first device and the communication device based on the first propagation time and the second propagation time.

16. The non-transitory CRM of claim 15, further comprising code for causing the communication device to determine a first distance between the first device and the communication device, when a NLOS condition is determined not to exist.

17. The non-transitory CRM of claim 15, wherein the first device is a tag in an ultra-wideband network and the communication device is an anchor in the ultra-wideband network

18. The non-transitory CRM of claim 15, further comprising:
code for causing the communication device to receive the first signal; and
code for causing the communication device to receive the second signal.

19. The non-transitory CRM of claim 15, wherein the first device and the communication device are ultra-wideband communication devices in a two-way ranging application.

20. The non-transitory CRM of claim 15, wherein the NLOS condition is determined to exist when a difference between the first propagation time and the second propagation time exceeds an error threshold.
